(19) United States
(12) Patent Application Publication
(10) Pub. No.: US 2023/0237385 A1
(43) Pub. Date: Jul. 27, 2023

(54) MULTI-AGENT REINFORCEMENT LEARNING PIPELINE ENSEMBLE

(71) Applicant: International Business Machines Corporation, Armonk, NY (US)

(72) Inventors: Lan Ngoc Hoang, Lymm (GB); Long Vu, Chappaqua, NY (US)

(21) Appl. No.: 17/583,522

(22) Filed: Jan. 25, 2022

(51) Int. Cl. G06N 20/20

(52) U.S. Cl. CPC G06N 20/20

(57) ABSTRACT

A computer-implemented method for configuring a plurality of machine learning pipelines into a machine learning pipeline ensemble is disclosed. The computer-implemented method includes determining, by a reinforcement learning agent coupled to a machine learning pipeline, performance information of the machine learning pipeline. The computer-implemented method further includes receiving, by the reinforcement learning agent, configuration parameter values of uncoupled machine learning pipelines of the plurality of machine learning pipelines. The computer-implemented method further includes adjusting, by the reinforcement learning agent, configuration parameter values of the machine learning pipeline based on the performance information of the machine learning pipeline and the configuration parameter values of the uncoupled machine learning pipelines.

### BACKGROUND

The present invention relates generally to the field of machine learning, and more particularly, to machine learning pipeline ensemble configuration.

Machine learning models are powerful tools for capturing data patterns and providing predictions. Systems of automated machine learning models and pipelines have quickly emerged in the recent years. Many machine learning systems employ an ensemble of different machine learning models to enhance the predictions and provide more robust/probabilistic forecasting, termed as pipelines.

Typically, a pipeline consists of a series of transformers followed by an estimator, each of which has a set of tunable hyperparameters. Most systems are tuned via a static indicator (i.e. a fixed representation of the criteria) in order to select the best performing pipeline for final output. Moreover, the performance of a machine learning pipeline may be measured by its running time and/or prediction accuracy. The performance often depends on the pipeline structure (i.e., how transformers and estimator are connected to form the pipeline structure) and values of the tunable hyperparameters of the transformers and estimator.

### SUMMARY

According to one embodiment of the present invention, a computer-implemented method for configuring a plurality of machine learning pipelines into a machine learning pipeline ensemble is disclosed. The computer-implemented method includes determining, by a reinforcement learning agent coupled to a machine learning pipeline, performance information of the machine learning pipeline. The computer-implemented method further includes receiving, by the reinforcement learning agent, configuration parameter values of uncoupled machine learning pipelines of the plurality of machine learning pipelines. The computer-implemented method further includes adjusting, by the reinforcement learning agent, configuration parameter values of the machine learning pipeline based on the performance information of the machine learning pipeline and the configuration parameter values of the uncoupled machine learning pipelines.

According to another embodiment of the present invention, a computer program product for configuring a plurality of machine learning pipelines into a machine learning pipeline ensemble is disclosed. The computer program product includes one or more computer readable storage media and program instructions stored on the one or more computer readable storage media. The program instructions include instructions to determine, by a reinforcement learning agent coupled to a machine learning pipeline, performance information of the machine learning pipeline. The program instructions further include instructions to receive, by the reinforcement learning agent, configuration parameter values of uncoupled machine learning pipelines of the plurality of machine learning pipelines. The computer program instructions further include instructions to adjust, by the reinforcement learning agent, configuration parameter values of the machine learning pipeline based on the performance information of the machine learning pipeline and the configuration parameter values of the uncoupled machine learning pipelines.

According to another embodiment of the present invention, a computer system for configuring a plurality of machine learning pipelines into a machine learning pipeline ensemble is disclosed. The computer system includes one or more computer system includes one or more computer processors, one or more computer readable storage media, and program instructions stored on the computer readable storage media for execution by at least one of the one or more processors. The program instructions include instructions to determine, by a reinforcement learning agent coupled to a machine learning pipeline, performance information of the machine learning pipeline. The program instructions further include instructions to receive, by the reinforcement learning agent, configuration parameter values of uncoupled machine learning pipelines of the plurality of machine learning pipelines. The computer program instructions further include instructions to adjust, by the reinforcement learning agent, configuration parameter values of the machine learning pipeline based on the performance information of the machine learning pipeline and the configuration parameter values of the uncoupled machine learning pipelines.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 is a block diagram of a computing system, generally designated 100, for configuring a pipeline ensemble including a plurality of machine learning pipelines 110, in accordance with at least one embodiment of the present invention;

FIG. 2 is a flow chart diagram, generally designated 200, depicting operational steps for respective reinforcement learning agents 120 coupled to machine learning pipelines 110 in accordance with at least one embodiment of the present invention;

FIG. 3 is a functional block diagram of a prior art system, generally designated 300, for training a pipeline ensemble utilizing an AutoML 330 system;

FIG. 4 is a functional block diagram of an exemplary system, generally designated 400 for configuring a pipeline ensemble implemented with an AutoML system 430, in accordance with at least one embodiment of the present invention;

FIG. 5 is a block diagram depicting components of a computing device, generally designated 500, suitable for performing a method for configuring a machine learning pipeline ensemble in accordance with at least one embodiment of the present invention;

FIG. 6 is a block diagram depicting a cloud computing environment 50 in accordance with at least one embodiment of the present invention; and

FIG. 7 is a block diagram depicting a set of functional abstraction model layers provided by clouding computing environment 50 (depicted in FIG. 6) in accordance with at least one embodiment of the present invention.

### DETAILED DESCRIPTION

The present invention relates generally to the field of machine learning, and more particularly, to machine learning pipeline ensemble configuration.

Embodiments of the present invention relate to various techniques, methods, schemes and/or solutions for configuring a pipeline ensemble including a plurality of machine learning pipelines. In particular, by connecting each machine learning pipeline to a reinforcement learning agent, each machine learning pipeline may be dynamically configured. In this way, performance of each of the machine learning pipelines may be individually altered, as well as the holistic behaviour at a pipeline ensemble level. This may ultimately deliver heterogenous machine learning pipelines with a desired overall system performance.

Embodiments of the present invention recognize that current methods for training pipeline ensembles do not self-adjust the individual machine learning pipelines dynamically via dynamic objective functions that take into account the heterogeneous nature of the pipelines. Specifically, current methods do not utilize available performance or configuration of adjacent pipelines. That is, machine learning pipelines are often only adjusted in light of new data, or based on monitoring indicators. Such adjustments do not link the configuration and performance of the machine learning pipeline, but instead treat these factors as independent components.

Moreover, it is typical for objective functions of the machine learning pipelines to remain. For example, such objective functions include minimizing prediction errors and minimizing entropy terms. This means that these independent machine learning pipelines do not benefit from the learning process and training process of each other, even when the different machine learning pipelines are exposed to different training datasets, frequencies, structures, etc.

Furthermore, training machine learning pipelines independently does not necessarily lead to a target system behavior, which may be needed to achieve a robust or resilient system (e.g., to collectively create a realistic range of predictions). Put another way, it may prove beneficial for a plurality of machine learning pipelines to be configured as an adaptive system that can have evolving functions for each machine learning pipeline, rather than having each machine learning pipeline simply providing the best output.

In order to overcome the above mentioned problems regarding machine learning pipeline training, embodiments of the present invention utilize distributed reinforcement learning agents to provide dynamic optimization objectives for a plurality of individual machine learning pipelines. Overall embodiments may aim to provide a dynamic machine learning pipeline group that not only adapts to individual reinforcement learning agent requirements, but can also provide dynamic group behavior in response to the output required from the system as a whole.

According to embodiments of the present invention, multiple reinforcement learning agents are used to tune a system consisting of multiple machine learning pipelines via individual pipeline performance data, as well as the configuration of other machine learning pipelines in the pipeline ensemble in order to better achieve overall system objectives. Compared to conventional automated machine learning systems, embodiments of the present invention provide individual automated machine learning pipelines coupled with reinforcement learning agents to provide dynamic optimization objectives. Such dynamic optimization objectives may be customized to the machine learning pipeline, as well as the overall system performance. The use of dynamic objectives via reinforcement learning agents drives the goal of each machine learning pipeline, and may be used to adapt an individual pipeline towards a cooperative or competitive behavior.

In other words, embodiments of the present invention create an evolving ensemble of members, wherein each member includes a reinforcement learning agent coupled to a machine learning pipeline. Typically, most pipeline ensembles are designed to provide outputs of the same type so that the best prediction is selected. The objective function of each of the machine learning pipelines is often the error of model predictions compared to the groundtruth data. In contrast, embodiments of the present invention provide dynamic objective functions for each machine learning pipeline via the coupled reinforcement learning agent. Moreover, such a dynamic setting of an objective function allows for the model behavior to evolve with different objectives, so that the pipeline ensemble may have a plurality of heterogeneous machine learning pipelines that provide predictions under different conditions and inputs.

In an embodiment, reinforcement learning agents automatically adjust their respectively coupled machine learning pipelines in response to criteria (such as excessive drifts in performance and lack of robustness/diverse predictions) from their own coupled machine learning pipeline, as well as other uncoupled machine learning pipelines. Thus, by coupling each machine learning pipeline with its own reinforcement learning agent, adaptive teaching of the machine learning pipeline may be achieved. Indeed, by further basing the adjustment of a machine learning pipeline on configuration parameters of other machine learning pipelines within the ensemble, individual and overall system performance may be appropriately altered.

In an embodiment, a plurality of reinforcement learning agents are provided, each of which are coupled to one of a plurality of machine learning pipelines. Each reinforcement learning agent ascertains performance information of the machine learning pipeline to which it is coupled, as well as configuration parameter values of other (uncoupled) machine learning pipelines. In this way, configuration parameter values of the coupled machine learning pipeline may be adjusted by the reinforcement learning agent. Thus, individual performance of the coupled machine learning pipeline may be changed by the reinforcement learning agent (i.e., by changing the objective function of the machine learning pipeline), while also benefitting from information regarding other (uncoupled) machine learning pipelines. In this way, overall system performance may also be adjusted and improved.

In an embodiment, the system for configuring a pipeline ensemble including a plurality of machine learning pipelines includes two types of components:

(i) A pipeline generation component configured to create multiple machine learning pipelines from different input datasets. Each pre-trained machine learning pipeline is associated with a reinforcement learning agent by the pipeline generation component.

(ii) A reinforcement learning agent attached to each machine learning pipeline. Each reinforcement learning agent is configured to monitor the machine learning pipeline performance. Further, the agent is configured to decide when and how to adapt a training dataset, a pipeline structure, an objective function, a learning environment, and/or a hyperparameter set based on the machine learning pipelines current performance on live or test data. This decision is ultimately made with consideration to the properties of other machine learning pipelines in the system. In addition, each reinforcement learning agent is configured to partially observe the configuration and performance of other (uncoupled/unassociated) machine learning pipelines to improve its adaptation of the coupled machine learning pipelines with regard to the collective/holistic system performance.

Examples of collective behavior may include collaborative behavior (i.e., to predict a wide ranges of outcomes) and competitive behavior (i.e., to converge to an accurate representation). The reinforcement learning agents may also exchange information to compare pipeline similarity and performance of the whole system. This exchange process may also be optimized via an attention mechanism to utilize exchange only between reinforcement learning agents coupled to pipelines which are most similar or different.

In some embodiments, the system for configuring a pipeline ensemble including a plurality of machine learning pipelines may be added to existing systems such as AutoAI with a new capability to perform under both an evolutionary selection setting (e.g., selection of the best performing model), and a collaborated/orchestrated learning setting (e.g., selection of the best prediction range from the ensemble). Further, reinforcement learning agents may set dynamic objectives for each machine learning pipeline so that the system can have heterogeneous machine learning pipelines. This may prove particular advantageous, for example, in an autonomous car machine learning system where some machine learning pipelines need to operate optimally while other machine learning pipelines are capable of operating under less than ideal conditions.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suit-able combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. If the term “adapted to” is used in the claims or description, it is noted the term “adapted to” is intended to be equivalent to the term “configured to”.

In the context of the present application, where embodiments of the present invention constitute a method, it should be understood that such a method may be a process for execution by a computer, i.e. may be a computer-implementable method. The various steps of the method may therefore reflect various parts of a computer program, e.g. various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

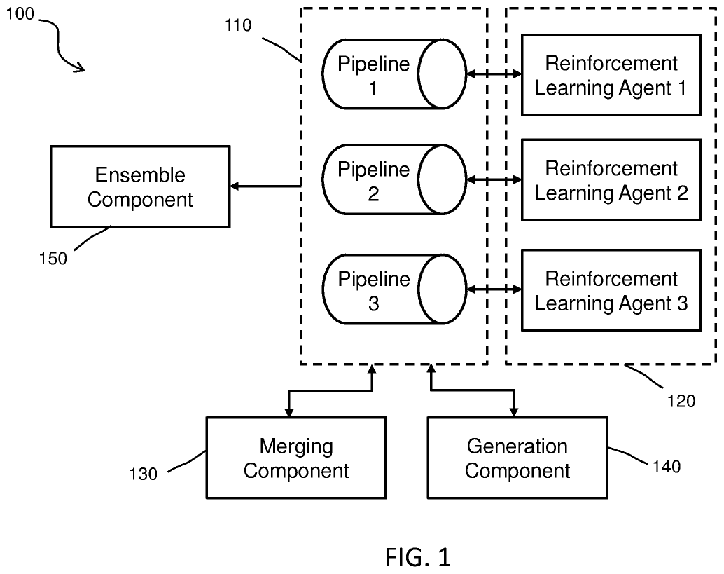

The present invention will now be described in detail with reference to the Figures. FIG. 1 is a block diagram of a computing system, generally designated 100, for configuring a pipeline ensemble including a plurality of machine learning pipelines 110, in accordance with at least one embodiment of the present invention. Computing system 100 includes a plurality of machine learning pipelines 110, coupled with a plurality of reinforcement learning agents 120. Optionally, computing system 100 may further include a merging component 130, a machine learning pipeline generation component 140, and an ensemble component 150.

Plurality of machine learning pipelines 110 are configured to receive an input dataset and output predictions based on the input dataset. Machine learning pipelines 110 may be any known machine learning/artificial intelligence algorithm suitable for predicting outputs based on received inputs. Each machine learning pipeline 110 may consist of a series of transformers followed by an estimator, each having a set of tunable hyperparameters.

Further, for each of the plurality of machine learning pipelines 110, a reinforcement learning agent 120 is associated with, coupled, or otherwise connected to machine learning pipeline 110. In other words, computing system 100 may comprise a plurality of reinforcement learning-machine learning pipeline pairs, each comprising a machine learning pipeline 110 coupled to a reinforcement learning agent 120.

In some embodiments, each of the machine learning pipelines 110 are heterogeneous. In this way, the pipeline ensemble may be adaptive to an array of different conditions. For example, it may be beneficial for some pipelines to provide good predictions under typical conditions, but also be robust under extreme, unanticipated conditions. Having an array of heterogeneous machine learning pipelines 110 is essential for this function. This may be achieved by dynamically setting objective functions, training datasets, learning environments, machine learning pipeline structures, and hyperparameter sets of each machine learning pipeline by the coupled reinforcement learning agent.

Each machine learning pipeline 110 may further have a number of configuration parameter values that are configurable. For example, a machine learning pipeline may have one or more configurable parameter values including, but not limited to, one or more of a re-configurable training dataset, learning environment, machine learning pipeline structure, objective function, and hyperparameter set.

Optional ensemble component 150 may be configured to generate a machine learning pipeline ensemble by combining plurality of machine learning pipelines 110. In this way, an artificial intelligence/machine learning model may be acquired, benefitting from the approach of the various (heterogeneous) machine learning pipelines.

Further, optional machine learning pipeline generation component 140 may be configured to generate plurality of machine learning pipelines 110 from a plurality of input datasets. This may be achieved by any known method(s) of producing a machine learning model. In this way, plurality of initiated machine learning pipelines 110 may be obtained. Moreover, for each of the plurality of machine learning pipelines 110, machine learning pipeline generation component 140 may be configured to couple the machine learning pipeline 110 with a reinforcement learning agent 120.

Furthermore, optional merging component 130 may be configured to determine a similarity value between each combination of the plurality of machine learning pipelines 110 based on performance information and configuration parameter values of the plurality of machine learning pipelines 110. Then, responsive to determining that the similarity value associated with the combination of machine learning pipelines 110 exceeds a predetermined threshold value, optional merging component 130 may merge a combination of machine learning pipelines 110. In this way, redundant machine learning pipelines may be removed, saving computational resources.

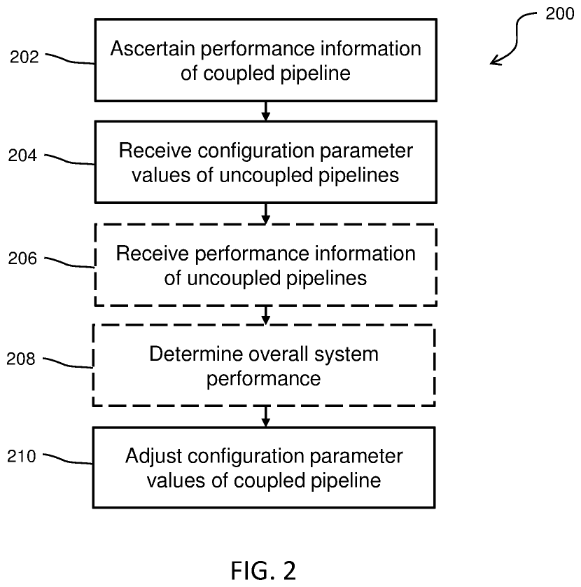

FIG. 2 is a flow chart diagram, generally designated 200, depicting operational steps for respective reinforcement learning agents 120 coupled to machine learning pipelines 110 in accordance with at least one embodiment of the present invention.

At step 202, reinforcement learning agent 120 ascertains performance information of the coupled machine learning pipeline 110. Performance information may include, but is not limited to, one or more of a prediction accuracy value, a prediction accuracy value drift, a diversity of predictions, a running time, and an entropy value.

At step 204, reinforcement learning agent 120 receives configuration parameter values of other uncoupled machine learning pipelines. In other words, reinforcement learning agent 120 obtains configuration parameter values (i.e. a training dataset, a learning environment, etc.) of machine learning pipelines 110 that are coupled to other reinforcement learning agents 120. Reinforcement learning agent 120 may receive this information directly from an uncoupled machine learning pipeline 110, or from a reinforcement learning agent 120 coupled to an uncoupled machine learning pipeline 110.

In some embodiments, reinforcement learning agent 120 is configured to receive configuration parameter values of a selection of the plurality of uncoupled machine learning pipelines 110. The selection may include uncoupled machine learning pipelines 110 that are most similar and/or most different to a coupled machine learning pipeline 110. In this way, information received by the reinforcement agent 120 may be the most relevant for adjusting the parameter values of the coupled machine learning pipeline (described below in relation to step 210). In other words, information exchange is optimized via an attention mechanism to utilize exchange only between reinforcement learning agents 120 coupled to machine learning pipelines 110 that are most similar or different (i.e., above or below a threshold degree of similarity). Similarity may be measured by a comparison of performance between machine learning pipelines 110 and/or the configuration parameter values of the machine learning pipelines 110.

At optional step 206, reinforcement learning agent 120 receives performance information of the uncoupled machine learning pipelines 110. Reinforcement learning agent 120 may receive this information directly from an uncoupled machine learning pipeline 110, or from another reinforcement learning agent 120 coupled to its respective coupled machine learning pipeline 110. The performance information may include, but is not limited to, one or more of a prediction accuracy value, a prediction accuracy value drift, a diversity of predictions, a running time, and an entropy value.

Responsive to receiving performance information of the uncoupled machine learning pipelines 110, at optional step 208, reinforcement learning agent 120 may determine overall system performance based on the performance information of the coupled machine learning pipeline 110 and the performance information of the uncoupled machine learning pipelines 110. Overall system performance may take into account overall deviation of predictions by the pipeline ensemble from one or more factors including, but not limited to, the ground truth, a range of predictions by the pipeline ensemble, and/or time taken to produce a prediction.

At step 210, the reinforcement learning agent 120 adjusts configuration parameter values of the coupled machine learning pipeline 110 based on the performance information of the coupled machine learning pipeline 110 and the configuration parameter values of the uncoupled machine learning pipelines 110. Accordingly, the teaching of the coupled machine learning pipeline 110 may dynamically compensate not just for its own performance, but also for the configuration of other machine learning pipelines 110. In other words, reinforcement learning agent 120 may leverage information available in other parts of the ensemble in order to ensure individual performance and overall system performance targets are obtained. Moreover, reinforcement learning agent 120 enables the dynamic learning of the machine learning pipeline 110, by being able to reconfigure the machine learning pipeline 110 (via features such as the dynamic objective, the hyperparameters and the pipeline structure).

In the case that reinforcement learning agent 120 is configured to perform optional steps 206 and 208, machine learning pipeline generation component 140 may be configured to generate a new machine learning pipeline responsive to determining that overall system performance indicates uncovered prediction settings. In this case, the full range of possible groundtruth values of a prediction may be covered by the pipeline ensemble.

Furthermore, in the case that reinforcement learning agent 120 is configured to perform optional steps 206 and 208, reinforcement learning agent 120 may adjust configuration parameter values of the coupled machine learning pipeline 110 based on the overall system performance, the performance information of the coupled machine learning pipeline 110, and the configuration parameter values of the uncoupled machine learning pipelines 110. In this way, desired overall system performance may be more effectively obtained. In some embodiments, reinforcement learning agent 120 is configured to adjust configuration parameter values of the coupled machine learning pipeline 110 based on the overall system performance compared to a desired collective system performance.

Put another way, typical machine learning pipeline systems individually train machine learning pipelines. This may not lead to desired overall system performance. Embodiments of the present invention overcome this issue by providing individual reinforcement learning agents 120 coupled to respective machine learning pipelines 110, which dynamically configure the coupled machine learning pipeline 110 based on overall system performance, individual coupled machine learning pipeline performance, and configuration parameters of uncoupled machine learning pipelines 110.

Desired collective system performance may comprise one of collaborative behavior, competitive behavior, or mixed competitive-collaborative behavior. Collaborative behavior is defined such that the plurality of machine learning pipelines 110 predict a wide range of outcomes. Competitive behavior is defined such that the plurality of machine learning pipelines 110 converge to an accurate representation.

By way of further explanation, collaborative behavior may mean that each reinforcement learning agent 120 adjusts configuration parameter values of its respective coupled machine learning pipeline 110 in such a way so as to avoid a situation in which multiple machine learning pipelines 110 provide similar outputs from similar inputs. However, the configuration parameter values of the coupled machine learning pipelines 110 are not adjusted so that outputs are provided too far from the ground truth. This enables better convergence to the probabilistic range of outcomes by the pipeline ensemble.

In this case, reinforcement learning agents 120 share a common goal to collaboratively provide a realistic range of predictions that cover the groundtruths population range. As such, the system may contain a step to poll predictions from individual pipelines to construct a distribution of predictions. To be robust, this distribution needs to be close to that of the groundtruth data. The system may then compute a distance measure between these distributions, such as a Kullback Leibler divergence or a Wassteiner divergence.

If the difference is under a predetermined threshold, only a portion of reinforcement learning agents 120 having a difference under the predetermined threshold may be required to adjust configuration parameter values of their coupled machine learning pipelines 110 with regard to performance requirements of the coupled machine learning pipeline 110. However, if the distribution of predictions and groundtruth are sufficiently different, the system may allocate a change requirement to each machine learning pipeline 110. This may involve the system identifying the main models giving rise to the distribution, and requesting reinforcement learning agents 120 coupled with identified machine learning pipelines to adjust configuration parameter values accounting for desired overall system performance. Overall, this may result in more spread out predictions by the pipeline ensemble, rather than convergence.

Conversely, competitive behavior may be such that the system aims to achieve the most accurate machine learning pipeline. In this case, all reinforcement learning agents 120 compete to get the best predictions from their coupled machine learning pipelines 110, and adapt configuration parameter values to beat the current best performing one. This may lead to faster convergence of the system. In this case, and conversely to collaborative behavior, the individual machine learning pipelines are not required to collectively provide predictions that match the groundtruth prediction (however, it may still be expected that the best performing models will provide predictions that are close to the ground truths). In other words, competitive behavior may mean that each machine learning pipeline-reinforcement learning agent pair treat other pairs as an adversary in order to arrive at the best prediction.

Finally, desired system performance may comprise of a mix between collaborative and competitive system performance. For example, this may be useful if the pipeline ensemble is required to provide ongoing prediction for a live system, such as in an autonomous car or operating infrastructure. Under this circumstance, the predictions are optimized for best performance (hence best model selection) under normal, low risk operating conditions, but are required to provide robust prediction that captures the possible risks under extreme, risky operating conditions. A conventional automated machine learning system will need separate pipelines or different systems to provide such predictions. However, with coupled reinforcement learning agents to vary the objective functions, it is possible to provide dynamic objective functions that switch a system from optimizing for competitive to collaborative behavior as risk indication values increase.

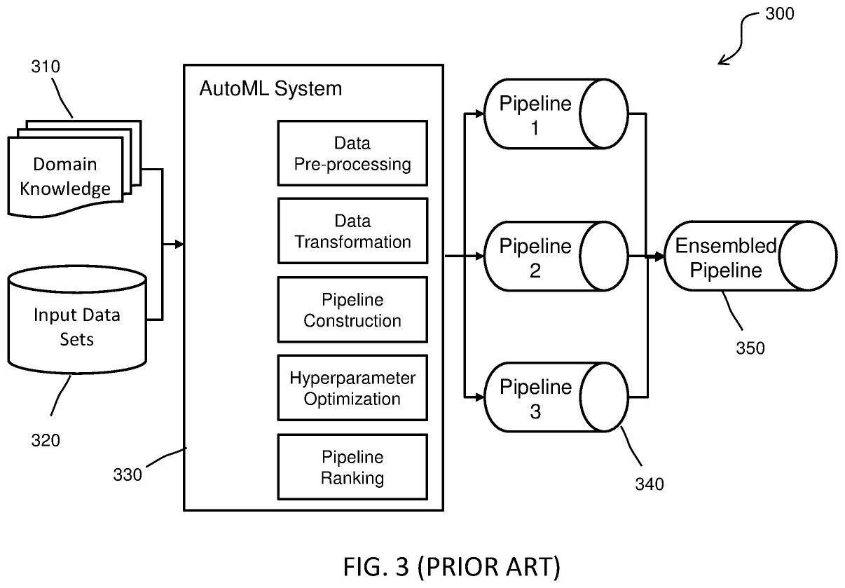

FIG. 3 is a functional block diagram of a prior art system, generally designated 300, for training a pipeline ensemble utilizing an AutoML 330 system. AutoML 330 system receives input datasets 320 and domain knowledge 310. Internal to AutoML 330 system, the inputs go through a series of steps including data preprocessing, data transformation, and pipeline construction. All constructed candidate machine learning pipelines are optimized and ranked with regard to performance metrics. Outputs are top k pipelines 340 with regard to performance metrics, which may be used to generate an ensembled pipeline 350.

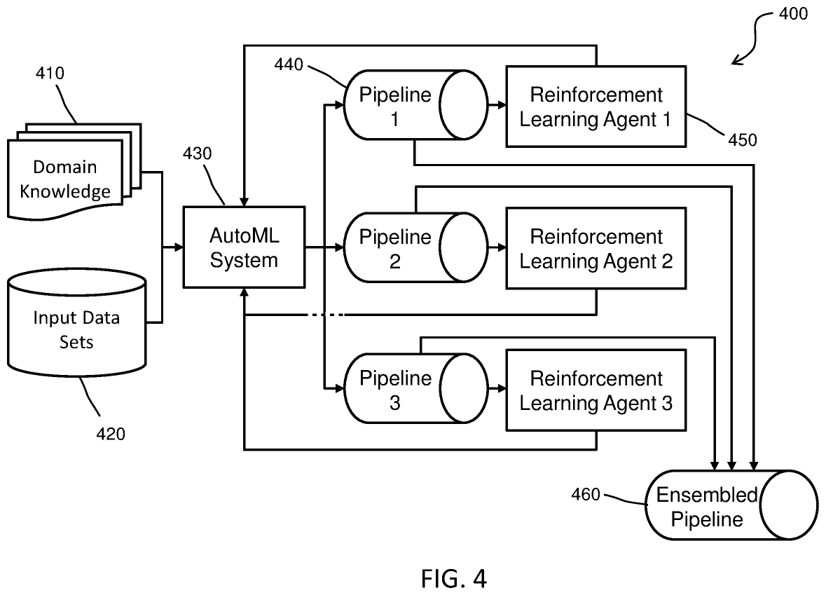

FIG. 4 is a functional block diagram of an exemplary system, generally designated 400 for configuring a pipeline ensemble implemented with an AutoML system 430, in accordance with at least one embodiment of the present invention.

Specifically, system 400 utilizes reinforcement learning agents 450 to tune respective linked machine learning pipelines 440 via feedback on machine learning pipeline performance information/scores, and also taking into account other unlinked machine learning pipelines 440 in the system 400, such that overall system objectives may be met. Desired overall system objectives may be configured such as to cover the whole range of outcomes, and/or fastest convergence.

The reinforcement learning agent—machine learning pipeline pairs may be coupled with automated machine learning pipeline systems 430 such as the AutoAI or AutoML systems (as depicted in FIG. 4). This creates an integrated system which may have the ability to modify pipelines by altering its structure, such as by adding or removing pipeline components, or tuning values of hyperparameters of its components.

Each of the machine learning models may resemble a pipeline of transformers and estimators which ingest data to produce predictions. The predictions produced by the plurality of machine learning pipelines 440 may then be pooled to provide the best final prediction.

According to some exemplary embodiments, producing a pipeline ensembled 460 using AutoML system 430 may comprise the following steps:

(i) An AutoAI/AutoML system 430 receives one or more system input datasets 420 and domain knowledge 410 as input, and outputs an ensemble pipeline 460 that combines multiple machine learning pipelines 440 to produce final prediction outcomes on unseen datasets.

(ii) The AutoML system 430 selects, for each input dataset 420, the best machine learning pipeline 440, using an internal hyperparameter tuning algorithm and pipeline construction algorithm. Each selected and pre-trained machine learning pipeline 440 is coupled to a separate reinforcement learning agent 450, and produces predictions for new datasets.

(iii) For each reinforcement learning agent 450: by analyzing predictions on the input datasets 420 by a coupled machine learning pipeline 440, and by inspecting the coupled machine learning pipeline 440 structure, hyperparameter spaces of all machine learning pipelines 440, and the global performance of the entire system, the reinforcement learning agent 450 generates appropriate actions for its respective coupled machine learning pipeline 440 (e.g., keeping or retraining the current hyperparameters or updating the data source and objective functions). In some embodiments, one or more machine learning pipelines 440 may be determined to be deleted due to being identical to other machine learning pipelines 440. Similarly, in some embodiments, one or more additional machine learning pipelines 440 may be determined to be created to cover an operating/prediction setting that haven't been covered by an existing machine learning pipeline 440.

(iv) Upon receiving actions from a reinforcement learning agent 450 for its respective coupled machine learning pipeline 440, AutoML system 430 follows the actions to update configuration parameter values of each of the machine learning pipelines 440.

(v) Steps (ii)-(iv) may be repeated until the entire system 400 converges.

(vi) A pipeline ensembled 460 is produced based on a combination of the machine learning pipelines 440.

By way of further explanation, each reinforcement learning agent 450 may consider the input data, other agents past actions to determine adjusted configuration parameter values for a coupled machine learning pipeline 440. For example, reinforcement learning agent 450 may be based on a reinforcement learning algorithm that can be a decentralized Q-learning system, in which the overall system 400 provides a Q-learning agent to provide guidance to individual reinforcement learning agents 450.

Each individual reinforcement learning agent 450 may then train a coupled machine learning pipeline 440 based upon on its own policy and transitions, which map from the system states to the optimal actions. The reinforcement learning agent 450 may consider various actions to adjust configuration parameter values of the coupled machine learning pipeline 440, such as:

(i) Retune the current machine learning pipeline 440 based on current obtained data (which might be different than the original data when created);

(ii) Reconfigure/prune/expand the machine learning pipeline 440, for example, by changing the architecture of the machine learning pipeline 440 or its optimization algorithms; and

(iii) Sample other machine learning pipeline 440 configurations to combine or part-copy the architecture and/or hyperparameters.

As a result, potential use cases for the reduced ensemble pipeline may exist in robust and resilient models for real life applications, such as cyber-physical systems, or in interlinked infrastructure such as communication networks, where an underlying machine learning system will need to consider the group behavior across all components.

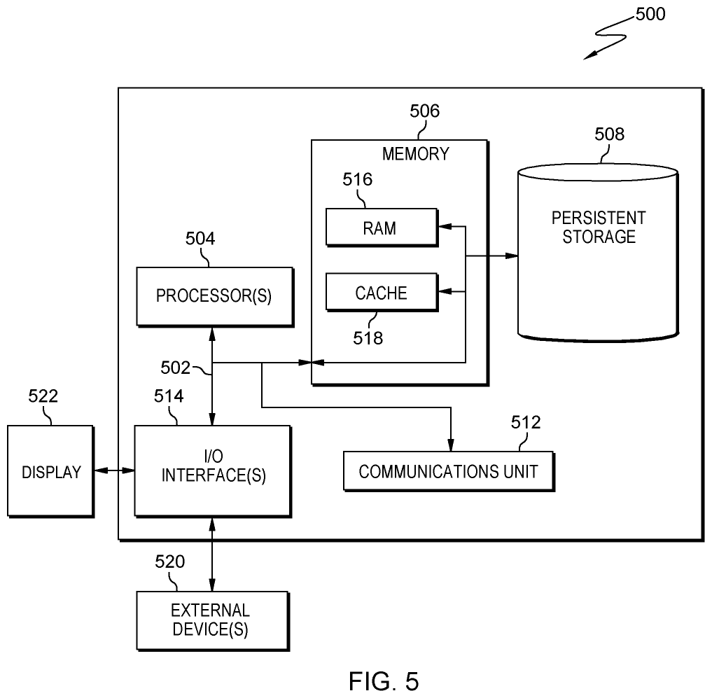

FIG. 5 is a block diagram depicting components of a computing device, generally designated 500, suitable for performing a method for configuring a machine learning pipeline ensemble in accordance with at least one embodiment of the present invention. Computing device 500 includes one or more processor(s) 504 (including one or more computer processors), communications fabric 502, memory 506 including, RAM 516 and cache 518, persistent storage 508, communications unit 512, I/O interface(s) 514, display 522, and external device(s) 520. It should be appreciated that FIG. 5 provides only an illustration of one embodiment and does not imply any limitations with regard to the environments in which different embodiments may be implemented. Many modifications to the depicted environment may be made.

As depicted, computing device 500 operates over communications fabric 502, which provides communications between computer processor(s) 504, memory 506, persistent storage 508, communications unit 512, and input/output (I/O) interface(s) 514. Communications fabric 502 can be implemented with any architecture suitable for passing data or control information between processor(s) 504 (e.g., microprocessors, communications processors, and network processors), memory 506, external device(s) 520, and any other hardware components within a system. For example, communications fabric 502 can be implemented with one or more buses.

Memory 506 and persistent storage 508 are computer readable storage media. In the depicted embodiment, memory 506 includes random-access memory (RAM) 516 and cache 518. In general, memory 506 can include any suitable volatile or non-volatile computer readable storage media.

Program instructions for performing a method for configuring a machine learning pipeline ensemble in accordance with at least one embodiment of the present invention can be stored in persistent storage 508, or more generally, any computer readable storage media, for execution by one or more of the respective computer processor(s) 504 via one or more memories of memory 506. Persistent storage 508 can be a magnetic hard disk drive, a solid-state disk drive, a semiconductor storage device, read-only memory (ROM), electronically erasable programmable read-only memory (EEPROM), flash memory, or any other computer readable storage media that is capable of storing program instructions or digital information.

Media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 512, in these examples, provides for communications with other data processing systems or devices. In these examples, communications unit 512 can include one or more network interface cards. Communications unit 512 may provide communications through the use of either or both physical and wireless communications links. In the context of some embodiments of the present invention, the source of the various input data may be physically remote to computing device 500 such that the input data may be received, and the output similarly transmitted via communications unit 512.

I/O interface(s) 514 allows for input and output of data with other devices that may operate in conjunction with computing device 500. For example, I/O interface(s) 514 may provide a connection to external device(s) 520, which may be as a keyboard, keypad, a touch screen, or other suitable input devices. External device(s) 520 can also include portable computer readable storage media, for example thumb drives, portable optical or magnetic disks, and memory cards. Software and data used to practice embodiments of the present invention can be stored on such portable computer readable storage media and may be loaded onto persistent storage 508 via I/O interface(s) 514. I/O interface(s) 514 also can similarly connect to display 522. Display 522 provides a mechanism to display data to a user and may be, for example, a computer monitor.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

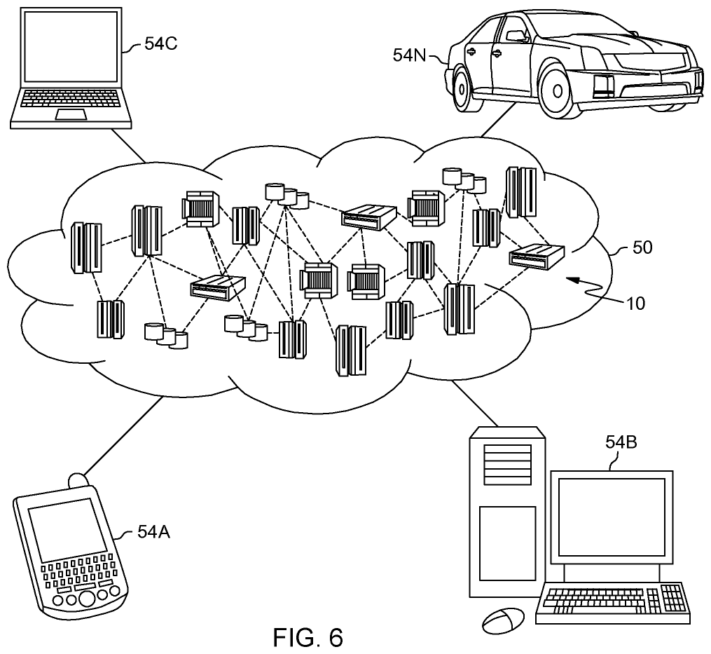

FIG. 6 is a block diagram depicting a cloud computing environment 50 in accordance with at least one embodiment of the present invention. Cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

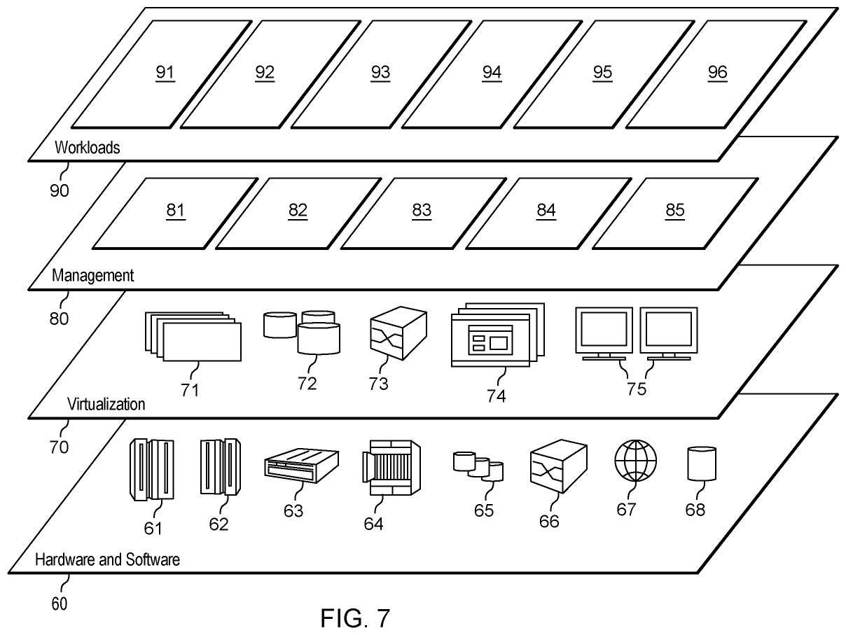

FIG. 7 is block diagram depicting a set of functional abstraction model layers provided by cloud computing environment 50 depicted in FIG. 6 in accordance with at least one embodiment of the present invention. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and machine learning pipeline ensemble configuration 96.

What is claimed is:

1. A computer system for configuring a plurality of machine learning pipelines into a machine learning pipeline ensemble, the system comprising:
one or more computer processors;
one or more computer readable storage media;
computer program instructions, the computer program instructions being stored on the one or more computer readable storage media for execution by the one or more computer processors; and
the computer program instructions including instructions for a reinforcement agent coupled to a machine learning pipeline of the plurality of machine learning pipelines to:
determine performance information associated with the coupled machine learning pipeline;
receive configuration parameter values from an uncoupled machine learning pipeline of the plurality of machine learning pipelines; and
adjust configuration parameter values of the coupled machine learning pipeline based, at least in part, on the performance information of the coupled machine learning pipeline and the configuration parameter values of the uncoupled machine learning pipeline.

2. The computer system of claim 1, wherein the plurality of machine learning pipelines are heterogeneous.

3. The computer system of claim 1, wherein the instructions for the reinforcement learning agent coupled to the machine learning pipeline to adjust the configuration values of the coupled machine learning pipeline further include instructions to:
receive performance information associated with the uncoupled machine learning pipeline;
determine an overall system performance of the plurality of machine learning pipelines based, at least in part, on the performance information of the coupled machine learning pipeline and the performance information of the uncoupled machine learning pipeline; and
readjust the configuration parameter values of the coupled machine learning pipeline based on the overall system performance.

4. The computer system of claim 3, wherein readjusting the configuration parameter values of the coupled machine learning pipeline is further based on the overall system performance compared to a desired collective system performance.

5. The computer system of claim 4, wherein the desired collective system performance includes at least one performance metric selected from the group consisting of collaborative behavior, competitive behavior, and mixed competitive-collaborative behavior.

6. The computer system of claim 1, further comprising instructions to:
determine a similarity value between the coupled machine learning pipeline and the uncoupled machine learning pipeline based, at least in part, on performance information and configuration parameter values of the coupled and uncoupled machine learning pipelines; and
merge the coupled machine learning pipeline and the uncoupled machine learning pipeline, responsive to determining that the similarity value associated with the coupled and uncoupled machine learning pipelines exceeds a predetermined threshold value.

7. The computer system of claim 3, further comprising instructions to:
generate a new machine learning pipeline responsive to determining that the overall system performance indicates uncovered prediction settings.

8. The computer system of claim 1, wherein the configuration parameter values of the coupled and uncoupled machine learning pipelines include at least one value selected from the group consisting of a training dataset, a learning environment, a machine learning pipeline structure, an objective function, and a hyperparameter set.

9. The computer system of claim 1, wherein performance information of the uncoupled machine learning pipeline includes at least one performance metric selected from the group consisting of a prediction accuracy value, a prediction accuracy value drift, a diversity of predictions, a running time, and an entropy value.

10. The computer system of claim 1, further comprising program instructions to:
generate a machine learning pipeline ensemble by combining the coupled and uncoupled machine learning pipelines.

11. The computer system of claim 1, further comprising instructions to:
generate the plurality of machine learning pipelines from a plurality of input datasets; and
couple each machine learning pipeline in the plurality of machine learning pipelines with a respective reinforcement learning agent.

12. A computer program product for configuring a plurality of machine learning pipelines into a machine learning pipeline ensemble, the computer program product comprising one or more computer readable storage media and program instructions stored on the one or more computer readable storage media, the program instructions including instructions for a reinforcement agent coupled to a machine learning pipeline of the plurality of machine learning pipelines to:
determine performance information associated with the coupled machine learning pipeline;
receive configuration parameter values from an uncoupled machine learning pipeline of the plurality of machine learning pipelines; and
adjust configuration parameter values of the coupled machine learning pipeline based, at least in part, on the performance information of the coupled machine learning pipeline and the configuration parameter values of the uncoupled machine learning pipeline.

13. A computer-implemented method for configuring a plurality of machine learning pipelines into a machine learning pipeline ensemble, the method comprising:
determining, by a reinforcement learning agent coupled to a machine learning pipeline, performance information of the machine learning pipeline;
receiving, by the reinforcement learning agent, configuration parameter values of uncoupled machine learning pipelines of the plurality of machine learning pipelines; and
adjusting, by the reinforcement learning agent, configuration parameter values of the machine learning pipeline based on the performance information of the machine learning pipeline and the configuration parameter values of the uncoupled machine learning pipelines.

14. The computer-implemented method of claim 13, further comprising:
receiving performance information associated with the uncoupled machine learning pipeline;
determining an overall system performance of the plurality of machine learning pipelines based, at least in part, on the performance information of the coupled machine learning pipeline and the performance information of the uncoupled machine learning pipeline; and
readjusting the configuration parameter values of the coupled machine learning pipeline based on the overall system performance.

15. The computer-implemented method of claim 14, wherein readjusting the configuration parameter values of the coupled machine learning pipeline is further based on the overall system performance compared to a desired collective system performance.

16. The computer-implemented method of claim 15, wherein the desired collective system performance includes at least one performance metric selected from the group consisting of collaborative behavior, competitive behavior, and mixed competitive-collaborative behavior.

17. The computer-implemented method of claim 13, further comprising:
determining a similarity value between the coupled machine learning pipeline and the uncoupled machine learning pipeline based, at least in part, on performance information and configuration parameter values of the coupled and uncoupled machine learning pipelines; and
merging the coupled machine learning pipeline and the uncoupled machine learning pipeline, responsive to determining that the similarity value associated with the coupled and uncoupled machine learning pipelines exceeds a predetermined threshold value.

18. The computer-implemented method of claim 14, further comprising:
generating a new machine learning pipeline responsive to determining that the overall system performance indicates uncovered prediction settings.

19. The computer-implemented method of claim 13, further comprising:
generating a machine learning pipeline ensemble by combining the coupled and uncoupled machine learning pipelines.

20. The computer-implemented method of claim 13, further comprising:
generating the plurality of machine learning pipelines from a plurality of input datasets; and
coupling each machine learning pipeline in the plurality of machine learning pipelines with a respective reinforcement learning agent.
